(19) United States
(12) Patent Application Publication
(10) Pub. No.: US 2011/0022477 A1
(43) Pub. Date: Jan. 27, 2011

(54) BEHAVIOR-BASED USER DETECTION

(75) Inventors: Kyle Davis Hatridge, Seattle, WA (US); Patrick Brian Wilburn, Redmond, WA (US); Aidan Stanley Marcuss, Seattle, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/509,227

(22) Filed: Jul. 24, 2009

(51) Int. Cl. G06Q 30/00; G06F 3/01

(52) U.S. Cl. 705/14.67; 715/745

(57) ABSTRACT

Techniques for observing user operations and recognizing a current user of a computer based on those operations. Characteristics of observed user operations are compared to characteristics of operations performed by known users, such as those users with existing user profiles. The current user may be recognized as a user having a known user profile or a new user, for which information on user interests or other profile information may be stored. The profile of the current user may be used to customize presentation of services according to preferences for the current user. Components that collect information on user interactions may be incorporated in an operating system of the computer so that user interactions with both the operating system and applications that access operating system facilities may be used to recognize a user. Customization of the operating system or other components based on inferred user recognition may improve the user experience.

### BACKGROUND

Components of a computer may customize the functions they perform based on the person using the computer (i.e., the user). For example, a software component may present a user interface with different color schemes to different users who have input different color preferences. Similarly, a software component may respond differently to user inputs, such as keyboard shortcuts or speech input representing dictation, to match the needs or speaking style of the user. As another example, different content may be provided to different users by computer programs, such as a news feed application that presents one set of news articles (e.g., political news) to one user and another set of news articles (e.g., sports news) to another user.

Computer components that support such customization may store information representing preferences expressed by different users in different user profiles. Each profile may be associated with a user name. As part of log on to a computer, a user may specify a user name, allowing the computer to retrieve a profile for that user and provide settings or other parameters to components executing on the computer that allow those components to customize the user's experience in some way.

In some instances, user profile information is used to support advertising-based software or service distribution models. Services provided through components such as web sites and some software applications, for example, are made available to users for free or for reduced price in exchange for an agreement by the user to receive advertisements as they use the software or services. In some instances, advertising may be provided directly in response to a detected operation, such as when a user accesses specific content on a web site, the application may respond by displaying a corresponding advertisement. In other cases, advertisements may be tailored to a user based on that user's preferences. When preference information is used, a user name used to log on to a computer may be used to associate a stored profile with a specific user of the computer. Information in a user profile for the user may be retrieved and provided to a server or other source of advertising. That server may select advertising believed to be of interest to the user based on profile information, so as to customize advertisements presented to the user. Being able to customize advertisements based on user preference is valuable to advertisers and may also be perceived as a value by some users because it increases the likelihood that advertisers will fund free software or services.

### SUMMARY

Conventional techniques for tailoring presentation of services by a computer component based on a user's preferences rely on different users having different user names and on provision of these user names to customize the presentation for the user. Without separate user names (or other user identifiers), services cannot be customized. However, Applicants have appreciated that computer users may use the same user name for different users. For example, multiple users may share a user profile or may not always log on with their own user profile. Conventional techniques could not customize presentation of services to these users, as the computer or component had no way to distinguish between users.

Applicants have recognized and appreciated that different users may use a computing device in different ways, and thus the manner in which a current user is using the computing device may provide an indication as to the identity of the current user. By observing user operations, then, a current user may be recognized and presentation of functionality, content, advertising or other services may be customized based on the identity of the current user. In some cases, when a current user is identified as being different from a user that is logged-in, the current user may be prompted to log in to his or her own user profile.

Described herein are techniques for observing user operations that interact with a computer or computer component (e.g., hardware or software part of a computer) and attempting to recognize the current user. Various exemplary types of user operations that may provide such an indication are described, as well as exemplary techniques for matching user operations to known users.

In one illustrative implementation discussed in greater detail below, a component may be an advertisement-supported operating system that customizes advertisements based on a current user's preferences. A first known user may log in to the advertisement-supported operating system and advertisements may be presented according to preferences of the first known user. Later, based on observations of user interactions with the operating system and/or with software applications programs being run on the computing device hosting the operating system (i.e., with computer components other than the one customizing presentation of services), the operating system may detect that user operations appear more similar to those of a second known user. The operating system may then determine that the second known user is the current user and present advertisements according to preferences of the second known user. In so doing, the advertisement-supported operating system may be more certain that advertisements are being customized appropriately and are reaching their intended audiences.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart of an exemplary process for operation of a computing device to customize presentation of services based on the identity of a current user;

FIG. 2 is a flowchart of an exemplary process for operation of a computing device to recognize a current user based on observing user operations;

FIG. 3 is a flowchart of an exemplary process for operation of a computing device to determine when a current user is a new user;

FIG. 4 is a flowchart of an exemplary process for operation of a computing device to collect user behavior data from seed groups for demographic categories to be used in recognizing a current user;

FIG. 5 is a flowchart of another exemplary process for operation of a computing device to recognize a current user based on demographic categories;

FIG. 6 is a block diagram of an exemplary process for operation of a computing device to manage user behavior data that may be used in some embodiments of the invention;

FIG. 7 is a flowchart of an exemplary process for operation of a computing device to apply statistical correlation techniques to recognize a current user based on information regarding one or more detected users;

FIG. 8 is a flowchart of an exemplary process for operation of a computing device to recognize a current user based on weighing differently various types of user operations and comparing to information on one or more detected users;

FIGS. 9A and 9B are diagrams of exemplary user interfaces that may be used in some embodiments of the invention;

FIG. 10 is a flowchart of an exemplary process for operation of a computing device to customize presentation of a advertisements by an advertisement-supported operating system based on an identity of a current user; and

FIG. 11 is a block diagram of an exemplary computing device with which some embodiments of the invention may operate.

### DETAILED DESCRIPTION

The Applicants have recognized and appreciated that advertising-supported software or services may be improved through a computer operating system that can recognize users based on characteristics of their interactions with software applications and other components on the computer. Based on such recognition, one or more user profiles may be accessed, allowing aspects of the operation of the computer, including advertisements presented to the user, to be customized for the user.

Individuals opting to use advertising-supported software or services will be exposed to advertisements regardless of whether those advertisements are tailored to the user's interests and preferences. Applicants have recognized that, though some users view advertisements as undesirable, as advertisements become more aligned with user interests, users are more likely to regard the advertisements as desirable. Moreover, as the likelihood increases that advertisements will reach an audience targeted by the advertiser, advertisers are more willing to financially contribute to advertising based software or services. Consequently, the range of software or services that are available to a user for free may increase, and the user experience when using that software or services may improve, as a result of providing an operating system that can recognize a user and match that user to a profile.

Advertisements may be tailored to users more readily for users if a user or characteristics of a user, like interests or hobbies, can be identified. Some conventional techniques for identification are based solely on user names, or other similar identifiers for a user. Applicants have appreciated that customization of presentation of services based solely on a user name may be useful in some environments, if each individual user is diligent about supplying an accurate user name each time the user accesses a computer or software program. In many cases, though, users are not so diligent.

Rather, it is often true that different users will access a computer or computer component using a common user name or will not change the user name when they take control of the computer from another user. For example, a family of four may have only one user name for a computer that all members of the family use when accessing the computer. Alternatively, even if each member of the family does have a separate user name, when one member of the family stops using the computer and another takes his/her place, the new family member will often not switch the user name so that the user name accurately describes a current user.

Accordingly, when customizing presentation of services to a current user based solely on user name, there is a significant chance that the customization will be done for a wrong user, as the actual current user will often not be accurately described by the user name.

Applicants have recognized and appreciated, however, that different users of a computer or computer component typically use the computer/component in different ways. For example, a child user may use video game programs more often than an adult user and an adult user may use spreadsheet programs more often than a child user. Further, different users may access different web pages based on users' individual preferences; for example, one adult user may often access sports team web pages and another adult user may often access travel-related web pages.

Applicants have therefore recognized that it may be possible to recognize a current user of a computer by detecting operations of the current user and matching characteristics of those operations to operation characteristics recorded for known users to recognize the current user as one of a set of known users or as a new user. If the current user is recognized as a known user, presentation of services by the component may then be customized with more certainty that the customization is being done correctly, according to previously-determined preferences of that known user. If the current user is determined to be a new user, the characteristics of operations of that user may be used to determine preferences for that user. The determined preferences for a recognized new user may be immediately applied to customize services for that user. Alternatively or additionally, the determined preferences may be stored for later use in customizing services whenever the same user again uses the computer.

Accordingly, described herein are techniques for observing user operations to recognize the current user. Once recognized, preferences of the current user may be determined or retrieved and used to customize presentation of services (e.g., advertisements) in any suitable manner. In some exemplary implementations described below, characteristics of user operations may be compared to characteristics of operations recorded for known users of a computer or computer component, such as those users with existing user profiles. If characteristics of the user operations match characteristics of a known user's operations, it may be determined that the current user is the known user. In some cases the operations of the current user may not match those of any known user with a pre-existing user profile for the computer component; in such cases, additional observations may be made to detect whether the operations are new indications of a known user—that is, new behavior of a known user—or behavior of a new user that does not have a user profile. In some implementations of the techniques described herein, if it is detected that the operations are indicative of a new user, the current user may be prompted to create a new user profile.

Techniques described herein may be used in any suitable way to customize presentation of services by a computer component.

In some cases, these techniques may be implemented by the computer component itself to detect operations of users with the computer component and customize presentation of services by the computer component. In other words, the techniques may form a part of the computer component that is customizing services. For example, a web browser application may include functionality to recognize users based on operations and customize presentation of advertisements or other services by the web browser application, or an operating system may include functionality to recognize users and customize presentation of advertisements or other services by the operating system for each user.

In other cases, though, the techniques may be implemented apart from the computer component that is being customized or apart from a component with which a user is interacting. For example, functionality may be provided in an operating system to detect operations of a user when the user is interacting with a software application, the operating system or other computer components executing on a same computing device as the operating system. In such cases, an operating system facility may recognize the current user as one having a user profile with the operating system and/or one having a user profile with one or more computer components. Upon recognizing the user, the operating system facility may provide information about the user. This information may be provided to a software application with which the user is interacting, such that the software application may customize presentation of services to the user. In other cases, the information may be provided to an advertising platform or other component that may influence the manner in which services are presented to the user.

Implementation of these techniques in an operating system may be particularly advantageous in some environments, as user operations with multiple computer components (e.g., multiple software applications) can be observed and more information can be used to recognize the current user of a computer, which may allow for more accurate and faster recognition than may be possible by observing interactions with only one component.

For ease of description, in examples given below techniques for recognizing a user are described in connection with one or more components, some of which may be contained in an operating system. However, it should be recognized that this description is exemplary and not limiting of the invention. For example, in some instances, a computer component may be provided by a combination of applications and/or a combination of application functions and operating system functions. Moreover, these components that provided services may do so as part of interaction with other components or devices, including as a result of interaction with web servers or other devices over a network.

It should be appreciated that, as used herein, a “known user” is a user of a computer component executing on the computing device that has a previously-created user profile with the computer component. The user profile may have been created explicitly by a user, based on express user input, and/or created by the component based on inferences about the user and observations of user behavior and operations. The user profile may include a user name and/or other identifier for the user, and may store any other suitable identifying information for the user, such as demographic information. Additionally, in some cases the user profile may be associated with one or more sets of preference information that may have been input by the user or inferred from the user's interactions with the computer component. In embodiments of the invention, demographic information and/or preference information may be used to customize presentation of services to the user.

A “new user” is a user of a computer component that does not yet have a user profile with the computing device or program. It should be appreciated, though, that some information about a new user may be stored, such as when a computer component is observing operations of a current user and detects that the operations do not match behavior of any known user. This information may be stored until a user profile is created for the new user, such as by prompting a current user to create a user profile or by automatically creating a user profile using the collected information. In the case where some information is stored about a new user, then, the information about the new user may be used in a similar manner to user profiles for known users, in that operation characteristics for a current user may be matched to operation characteristics stored in the information about the new user, such that a current user may be matched to the new user before a profile is created for the new user.

A “current user” is a person governing operations of a computer component at a particular time. The current user may be different from a “logged-in user” that has previously provided user profile information to the computer or computer component, such as by identifying him- or herself by providing a user name or other identifier. Thus, the current user may or may not be identified by the user name or other identifier of the logged-in user.

A “detected user” is a user for which, as a result of observing user interactions with the computer, a data set similar to a user profile has been created and can be used to recognize a current user. A detected user may be described by a collection of interaction patterns, observations of user operations and behavior or other characteristics of user interaction with the computer. A detected user may correspond to a known user, and a known user may correspond to one, two, or more detected users that each describe attributes of the known user. In some embodiments of the invention where information about new users is collected, the information about the new user may be collected in the form of a detected user data set, such that the detected user may correspond to a new user.

A detected user data set may contain or be associated with information that serves the purpose of a user profile. A user profile may store preference information that may be used to customize presentation of services. A detected user data set may also contain information corresponding to the preference information that may be stored in a user profile. In some embodiments of the invention, when operations of a current user are being observed, a detected user data set for the current user may be assembled. The characteristics of operations of the current user stored in the detected user data set created for the current user may be used to assign the current user to interest categories or otherwise determine user preference in information. The characteristics of user operation also may serve as a way to associate the detected user with a known user. The current user may then be recognized as the known user, and the preference information for the known user may then be retrieved from the known user's user profile to customize presentation of services for the current user. Alternatively or additionally, information from the detected user data set of the current user data set may be used to update stored information for the known user. The current user data set, for example, may be used to update stored preference information for the known user or to update patterns or user categories that characterize the known user. Additionally, in some embodiments of the invention, when a current user is recognized as a known user, the current user may be prompted to log in as the known user.

Techniques described herein for recognizing a current user are described generally in terms of performing the recognition to customize presentation of services to the current user. It should be appreciate that a “service,” as used herein, is any suitable procedure for accepting input from a user and/or providing output to the user. A service can be customized in terms of presenting output to a user, including customizing either or both of content of the output and a manner in which it is generated and/or rendered, as well as in terms of a manner of accepting input from a user and/or processing the input, as embodiments of the invention are not limited in this respect. In some exemplary embodiments of the invention described below, a “service” may be described in terms of presentation of advertising content to a user, such that advertising content may be tailored to preferences or interests of a user to ensure that an advertisement is matched to a user that may be interested in that advertisement. Advertisers may be willing to pay more for advertisements that will be presented to users in a specific target audience, so customizing advertisements in this way may provide more revenue for software (such as operating systems) that are primarily supported by advertising income. It should be appreciated, though, that other embodiments of the invention may customize presentation of any other services in any other way, including customizing any suitable content or functionality of a computer or a component of a computer.

Some embodiments of the invention relate to observing user operations to recognize a current user. It should be appreciated that, as used herein, an “operation” may be any suitable interaction between a user and a computer component—including computer components other than the one customizing presentation of services. For example, where an operating system of a computing device may be customizing a service, operations that interact with a software application executing on the computing device (other than the operating system) may be observed and used by the operating system to customize presentation. An operation may be an action taken by a current user to request any component of a computer to perform some task or execute some function, including executing, retrieving, or presenting some particular kind of content. For example, an operation may include requesting that a particular software application be run or a particular web page be retrieved. An operation may also be the input of some information to the computing device or program, such as where a current user inputs text into a word processor, a query into a search engine, and/or identifying information (such as program usernames or e-mail addresses) into a form in a web page or application. Operations may be observed in any suitable manner to determine information about a current user and recognize the current user, examples of which are described in greater detail below. In some of these examples, particular input may be observed, a particular style of input or a device used to provide input may be observed, frequency of input may be observed, or any other characteristic may be observed. This observation may happen directly, by a computer component that is customizing presentation, or indirectly, such that the computer component receives information about operations from other components that were the subjects of the operation. An example of an indirect observation is an operating system that receives information from a software application regarding a user operation that interacted with that software application, rather than user input provided directly to the operating system itself.

In many embodiments of the invention, observation and analysis of user operations will be carried out entirely locally, within a computer component doing the observation and/or customizing presentation of services, to prevent any user-identifiable information from being transmitted outside the computer or component. It is often undesirable to transmit this information outside the computer or component because the information could be intercepted by unauthorized third parties and used in unintended ways. However, it should be appreciated that embodiments of the invention are not limited to performing the observation and/or analysis entirely locally, as transmitting the information outside the computer or component may not be a concern in some environments or may be done securely in some environments. In this latter case, all or a portion of information contained within a user profile may be transmitted outside a computer or component, such as demographic information for a user or a level of interest in a particular topic. Alternatively, user information may be used to derive some classification(s) for a user that cannot identify the user, and these may be transmitted outside the computer or component without fear that user-identifiable information may be intercepted and misused.

The techniques described herein may be used in any number of environments and in any number of ways. For illustration, which may aid in understanding the description given below, one example is now described. In the example, a computer may have executing on it an operating system that permits different users to create user accounts and that allows for presentation of services to be customized based on profile information stored in association with a user account. For example, user interface options like color schemes may be customized. The operating system of the example may have two user profiles: a user profile for a first user named Tom and a user profile for a second user named Sally. These two user profile may have been in use for a long time, and an operation observance facility executing on the operating system may have previously stored information on how Tom and Sally each typically use the computer and interact with the operating system and with software applications executing on the computer.

In this example, Tom logs in to the operating system by providing his username or other information and the operating system may access a profile stored for Tom and customize the presentation of the services according to his preferences (which he may have previously input). Services may be customized in this way for some amount of time. During this time, the operation observance facility executing on the computing device may be observing the operations of a current user of the computer, which is the person operating the computer at a given time. The operations of the current user may, immediately after Tom logs in, match expected characteristics of Tom's operations. For example, the current user may access web pages that Tom is known to access regularly.

At some later time, however, the operation observance facility may detect that characteristics of the current user's operations no longer match Tom's characteristics. The discrepancy between the current user's operation characteristics and Tom's operation characteristics may be because Tom has stopped using the computer and walked away without logging out of his user profile and Sally has started using the computer without logging in under her own username. The operation observance facility, while observing the current user's operations, may detect that the current user is using the computing device in a way that is more like Sally than Tom. For example, the current user may be accessing web pages that Sally is known to access regularly. Using the techniques described below, the operation observance facility may recognize Sally and determine that the current user is actually Sally, even though Tom is the logged-in user. Upon making this determination, the operation observance facility may ask the current user whether he/she is actually Sally, rather than Tom, and/or begin customizing presentation of services based on Sally's preferences.

Various other examples are given below to provide greater understanding of ways in which embodiments of the invention may operate. In some of these examples, a current user is interacting with a computer component that is an operating system of a computing device and, based on observations of user operations, the presentation of particular content by the operating system (e.g., advertising content) is customized for the current user. In embodiments of the invention that customize presentation of content like advertising content, it should be appreciated that the customization of presentation may be done in any suitable manner, such as by selecting advertisements to be presented or receiving selected advertisements from a remote computer, such as via the Internet. It should be appreciated, though, that embodiments of the invention are not limited to working with an operating system, but rather any suitable computer component, including any suitable computing device and/or software program, may implement these techniques for recognizing users and customizing presentation of services. Further, as discussed above, the presentation of any suitable service may be customized, and customizing presentation of content is only one example.

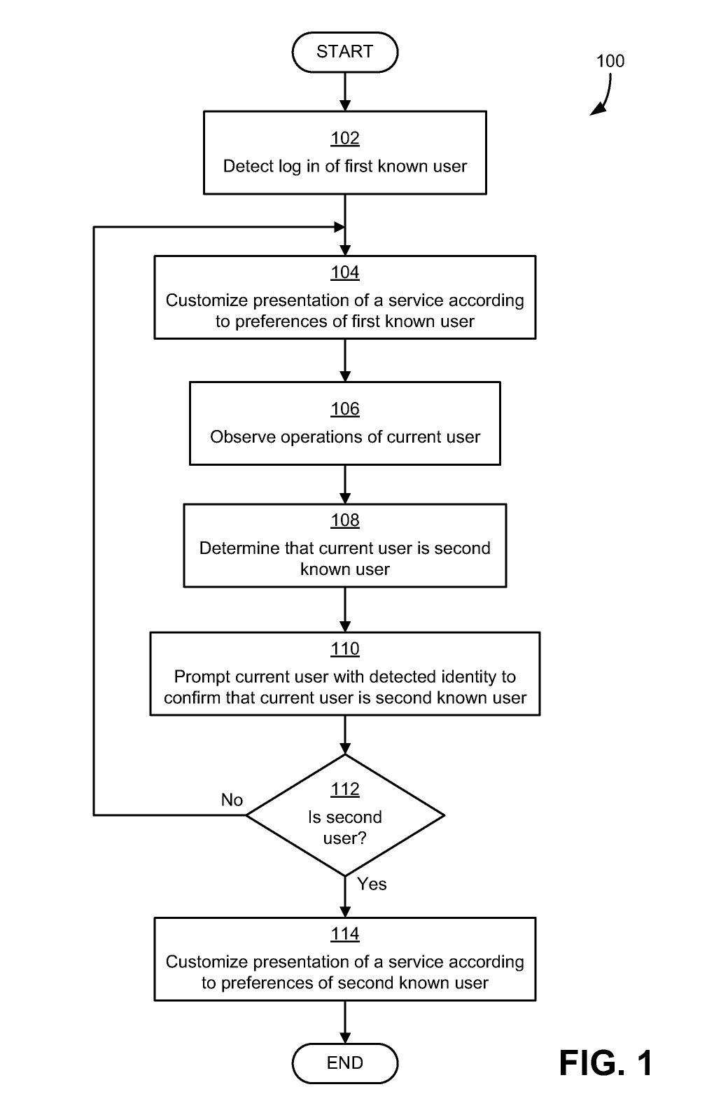

FIG. 1 shows one exemplary technique for operating a computer to recognize a current user of the computer and customize presentation of some service based on that current user's preferences. These operations may be performed by any one or more components of the computer.

The process 100 of FIG. 1 begins in block 102, in which the computer component detects that a first known user is logged-in to the component. This may be done in any suitable manner, as embodiments of the invention are not limited in this respect. For example, the computer component may detect that the first known user has carried out a log-in process by providing a user name directly to the component or to another component of the computer system.

In block 104, presentation of at least one service is customized based on preferences of the first known user. Preference information for a known user may be stored in connection with a user profile for the user, which may be a collection of information that was explicitly input by the user or inferred about the user. Input information may be a listing of one or more of the user's interests, category(ies), information on a degree of interest in one or more areas, a listing of the user's likes or dislikes with respect to the service(s) or a way in which the service is presented, and/or any other information. When a service is to be presented to the user, the preference information for that user may be retrieved and used to customize presentation of the service in any way. As discussed above, this may involve customizing content that is presented by the service and/or a manner of presenting the content (e.g., display of the content), among other things.

In block 104, in response to detecting that the first known user is logged-in in block 102, preference information for the first known user may be retrieved and used to customize presentation of the service(s). Preferences of the first known user are used to customize the presentation because an assumption may be made that, because the first known user is logged in, a current user that will view and interact with the service(s) is the first known user. However, as discussed above, it should be appreciated that the current user may not always be the logged-in user—because, for example, two or more users may share user log-in information or the first user may have wandered away without logging out of the component and a second user may be using the component under the first user's profile—and thus the current user of the component may not be the first known user. As discussed above, though, it may be advantageous to ensure that services are customized according to the preferences of the actual current user.

In accordance with techniques described herein, then, in block 106 operations of the current user when interacting with the computer component and/or other utilities or components of a computer system may be observed. In some embodiments of the invention, observation of user operations may only be carried out when a user has consented to such observation, such as when a user has requested that services be customized according to the user's preferences and has elected to have his/her operations observed to improve that customization. Consent may be given explicitly by a user in some embodiments of the invention or may be inferred in some embodiments of the invention, such as when a user purchases or uses free, advertising-supported software.

Observation may be carried out in any suitable manner, including by an observation facility included in the computer component that is customizing presentation of services according to preferences of a current user. The observation facility may observe any operations that interact with a computer or computer component by which a user may be recognized, and may derive any suitable characteristics or properties from the observed operations. Observation may be carried out of a particular operation or type of operation carried out by the current user, including any suitable properties of the operation. For example, a way in which the operation was input to the computer component, such as which input device was used (e.g., mouse, keyboard, etc.) or a speed at which the operation was input, may be detected. In other cases, a particular content of the input may be detected, such as words or phrases entered by the current user. For operations that request a type of output, the output requested may be detected. Any suitable operation, and any suitable property of an operation, may be analyzed to ascertain characteristics of user interaction with the computer, as embodiments of the invention are not limited in this respect.

In block 108, after observing operations of the current user, it may be determined that the current user is not the first known user (i.e., not the logged-in user). Further, it may be determined that the current user is a second known user. This determination may be made in any suitable manner, some examples of which are described in greater detail below.

In block 110, regardless of how the determination of block 108 is made, in block 110 the current user may be prompted to confirm the determination. For example, a user interface may be used to present some information about the determined identity of the current user for confirmation. The user interface may present a user name or other information about the second known user (whom the current user was determined to be in block 108) and request that the current user confirm that he or she is the second known user. It should be appreciated, though, that not all embodiments of the invention may request such confirmation.

In block 112, it is determined whether the current user confirmed that he or she is the second known user, as determined in block 108. If not, then the process 100 may return to block 104 by customizing presentation of services according to preferences of the logged-in user (i.e., the first known user) and observing operations of the current user in block 106. This may be done to acquire more information about the current user, by observing more operations, to recognize the current user. If the current user is neither the first known user nor the second known user, then, it may be determined based on further observation that the current user is a third known user. Or, if the current user was, at the time he/she was prompted in block 110, the first known user, it may be determined at a later time that the current user is no longer the first known user.

If, however, in block 112 the current user confirms that he/she is the second known user, in block 114 the preferences of the second known user are used to customize presentation of services. In this way, despite that the first known user is logged in, the services may be customized more appropriately for the actual current user (i.e., the second known user). This may provide a more pleasant user experience for the current user, by customizing services according to his/her own preferences rather than another user's. Further, in the case of paid services such as advertising, more money may be made by ensuring that an advertisement reaches its target audience by ensuring that advertisements are shown to the actual current user.

After the services are presented in block 114, the process 100 ends.

Process 100 shows, generally, how some techniques described herein may be used to customize presentation of services of a computer component to a current user regardless of which user may be logged-in to the computer. As shown in FIG. 1, operations of the current user may be observed to recognize the current user as one of a set of known users. Embodiments of the invention operating according to the exemplary process shown in FIG. 1 may be implemented in any suitable manner to make this determination.

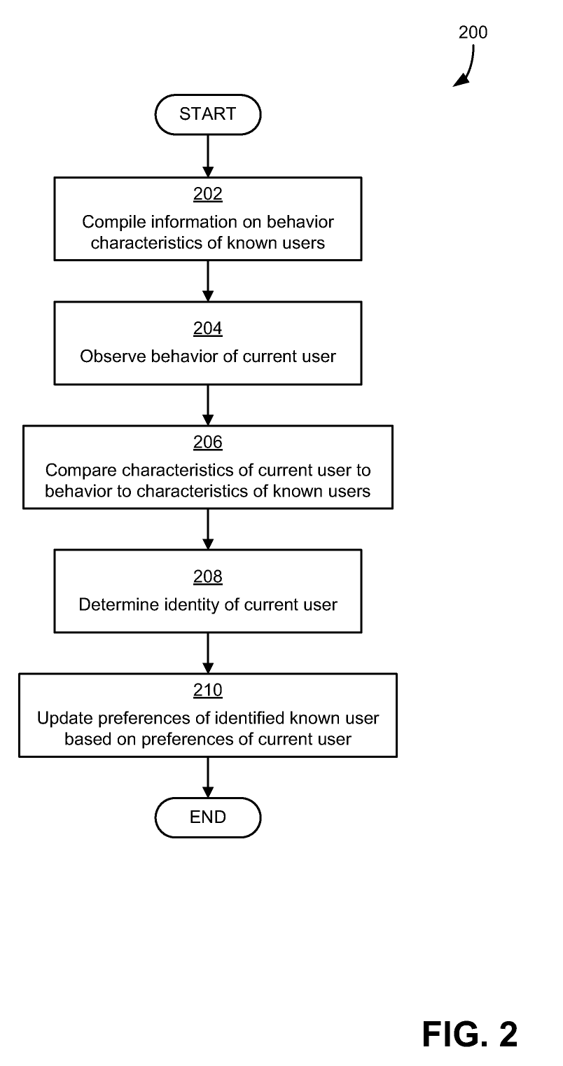

FIG. 2 shows one process 200 that may be used to recognize a current user based on observing operations of the current user. Process 200 begins in block 202, in which information on behavior characteristics of known users is compiled. Block 202 may be done in any suitable manner, including by observing operations of known users. Some information about known users may be compiled by observing one operation of a known user while other information may be compiled through repeated observation of various operation of a known user over time. For example, if a user logs in to a website using a particular user name for that web site, or uses a particular e-mail address, that user name or e-mail address may be associated with the known user and stored in block 202 after one operation. As another example, if a user tends to execute a spreadsheet application program often and tends not to play computer games often, information on these trends may be collected from observing operations of the known user over time.

In cases where each user has a distinct, pre-existing user profile, compiling information in block 202 may comprise tracking information on known users following log-in by the known users with their own user profiles. Information on behaviors collected in this way may, in some cases, be compiled only immediately following log-on, for some determined amount of time, to avoid compiling information about behavior of a user other than the logged-in user, though this is not necessary. Alternatively, a known user may volunteer to have his/her operations observed for a given period of time, to help train an observation facility with information on his/her behavior. These may be the simplest ways of compiling information on behavior characteristics of known users. In other techniques, characteristics may be aggregated until trends can be identified as corresponding to distinct users. For example, trends in behavior may be matched to specific time periods, such as different types of behavior in the early evening and late at night that may correspond to two different users that use a computer or component at different times. As another example, trends may be identified as specific types of input that may vary between users and may be used to identify possible distinct users (e.g., e-mail addresses). Any suitable trend may be identified. These trends, once identified, may be used to separate aggregated characteristics from a large span of time and possibly multiple users into distinct user profiles, each including characteristics on behavior of the known users to which they correspond. Any other suitable technique may be used to compile behavioral characteristic information on users.

Based on the information compiled on the known users, various characteristics may be identified. For example, a characteristic speed of operations, a characteristic way of performing operations (e.g., which input device is used), characteristic input such as words or phrases, characteristic content, and/or characteristic programs and processes may be identified. Any suitable characteristic(s) of behavior may be identified based on analysis of the information compiled in block 202. The foregoing are exemplary and any suitable characteristics may be used. For example, it should be appreciated that the same information and techniques used to characterize known users may be used in characterizing detected users, and vice versa.

In many embodiments of the invention, the compiling of block 202 may only be done for users that have “opted-in” to a compiling process. This may be done to defer to the user's wishes regarding privacy and avoid compiling information on users that do not wish to be tracked or monitored. In other embodiments of the invention, though, users may not be concerned about tracking and monitoring, and compiling of block 202 may be done without an opt-in process.

In block 204, behavior of a current user is observed, such as by observing operations of the current user. As discussed above, any suitable operation may be observed in any suitable manner. For example, various properties of operations may be observed directly, by a component the will customize presentation of services to the current user based on the identity of the current user, or indirectly, by other components of a computer system that will provide information on operations to the component. Behavior and operations may be observed in any suitable manner.

Based on the operations observed in block 204, various characteristics of the behavior of the current user may be identified. For example, any of the characteristics described above may be identified: operation speed, way of performing operations, frequent or common inputs, frequent or common contents or data that is accessed by a user (e.g., documents or web pages), frequent or common applications that are used/executed, etc. Any suitable characteristic may be identified.

In block 206, then, the characteristics of the observed operations of the current user from block 204 may be compared to characteristics of one or more known users compiled in block 202. Based on this comparison, similarities may be detected between the behavior of the current user and behavior of one or more known users. This comparison may be carried out in any suitable manner, examples of which are described in greater detail below.

Based on this comparison of block 206, and/or through application of one or more statistical correlation techniques—such as those used in regression analysis or segmentation problems—one known user may be identified as more likely than others to be the current user. This may be because the behavior of this known user more closely matches the behavior of the current user. The current user may then in block 208 be identified as this known user.

In block 210, as in block 202, information may be compiled for the known user identified in block 208 about preferences of the current user. This additional information may be used in block 210 to update preferences of the known user identified in block 208, to be used in customizing presentation of services to the known user. Information about preferences may be collected in block 210 in any suitable manner, including by observing operations of the current user and inferring preferences and/or by prompting the current user to input preference data for a user profile. Further, in block 210, information on operations carried out by the current user may be used to update the behavior characteristics of the known user identified in block 208.

Once the preference information for the known user has been updated in block 210, the process 200 ends. It should be appreciated, though, that in some embodiments of the invention, rather than ending, the process 200 may return to block 204 and continue observing behavior of the current user and attempting to recognize the current user. The process 200 may be implemented this way when it is executing as a background process and may be executing throughout the duration of operation of a computer component to recognize a current user of the computer component.

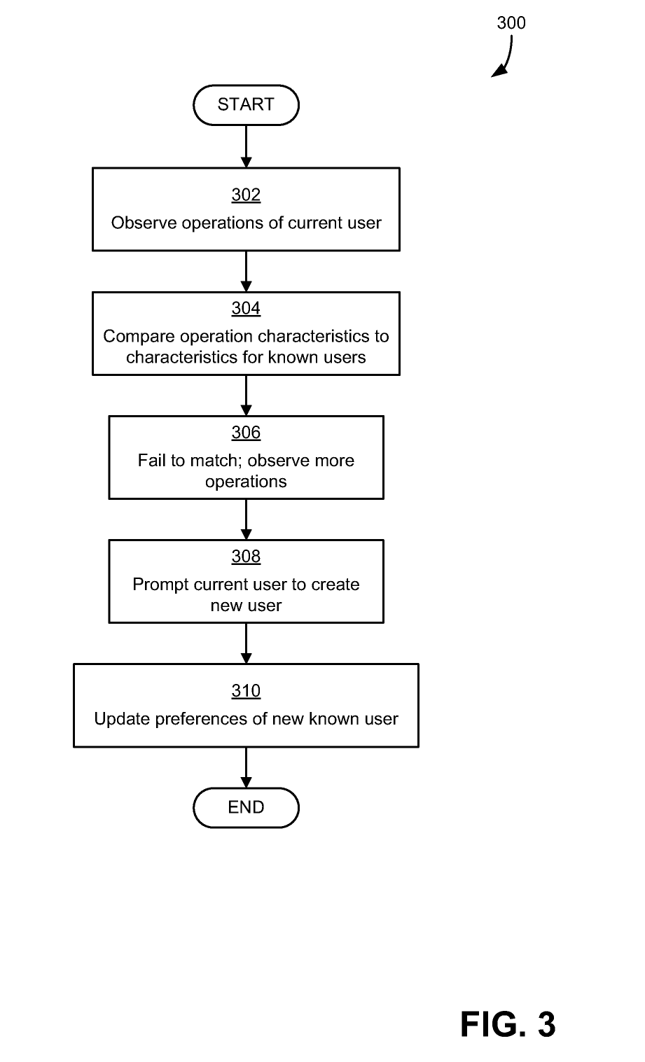

The process of FIG. 2 focuses on matching behavior of a current user to that of known users, to identify the current user as one of the known users. It should be appreciated, however, that in some cases the current user may not be a known user and may instead be a new user. This may be because the current user has not used the computer component before or may not have been detected as a different user before. The process 300 of FIG. 3 is one example of a process that may be followed to identify a current user as a new user.

The process 300 begins in block 302 by observing operations of a current user. As outlined above in connection with FIGS. 1 and 2, observing operations of a user may be carried out in any suitable manner. Based on this observation, various characteristics of behavior of the current user may be identified. In blocks 304, the characteristics of behavior of the current user may be compared to characteristics of behavior of known users, as discussed above in connection with block 206 of FIG. 2.

The comparison of block 304, however, may fail to match the characteristics of the behavior of the current user to any of the known users (because, in this case, the current user is a new user). In the case of such a failure, in block 306 additional operations of the current user may be observed and additional characteristics may be determined. This may be done in block 306 to confirm that the current user is not a known user, such as by determining new or additional characteristics of the current user's behavior and determining whether these new/additional characteristics match characteristics of the current user.

In block 308, after observing more operations of the current user and confirming that the current user is not a known user, the current user may be determined to be a new user and prompted to create a new user profile. The prompting of block 308 may be carried out in any suitable manner, including by displaying, via a user interface, a graphic prompt requesting that the current user confirm that he/she is a new user and requesting that he/she create a new user profile.

In block 310, after the user profile is created for the new user, preferences of the new known user may be updated. This may be carried out in any suitable manner, examples of which are discussed above in connection with block 210 of FIG. 2. For example, information may be collected by observing operations of the current user and/or by prompting the current user to input preference data. Further, in block 310, information on operations carried out by the current user may be used to update the behavior characteristics of the new known user, such that in the future these behavior characteristics may be used to identify a current user as the new known user.

Following the updating of block 310, the process 300 ends. Though, as discussed above in connection with FIG. 2, in some embodiments of the invention the process 300 may not end, but rather may loop back to block 302 to continue observing operations of the current user.

It should be appreciated that processes illustrated in and described in connection with FIGS. 2 and 3 for matching behavior characteristics of a current user to behavior characteristics of known users are only examples of ways that a current user may be identified. Further, it should be appreciated that while, for ease of illustration and description, the processes of FIGS. 2 and 3 are shown as separate processes, in some embodiments of the invention these two processes may be implemented as a single process for recognizing a current user. In the single process, one of the two processes may be followed depending on whether the current user can be recognized as a known user. If so, the process of FIG. 2 may be followed, but if not, the process of FIG. 3 may be followed.

It should be appreciated, though, that these processes, and the single process that combines these processes, are only illustrative of the ways in which embodiments of the invention may recognize a current user. The current user may be recognized in any suitable manner in accordance with the principles described herein, as embodiments of the invention are not limited to any particular technique.

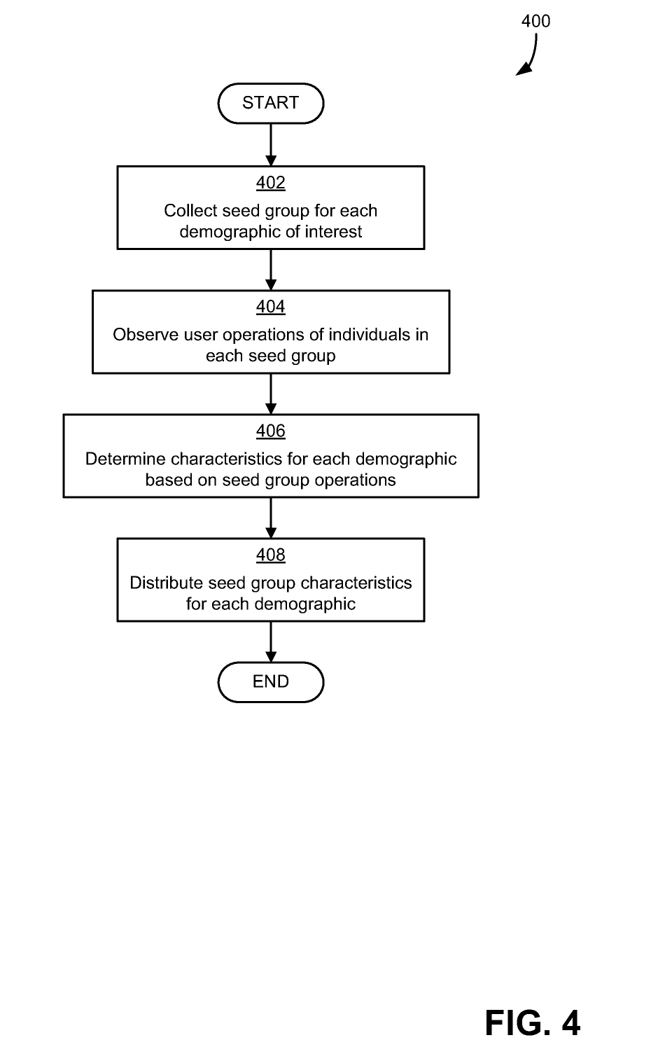

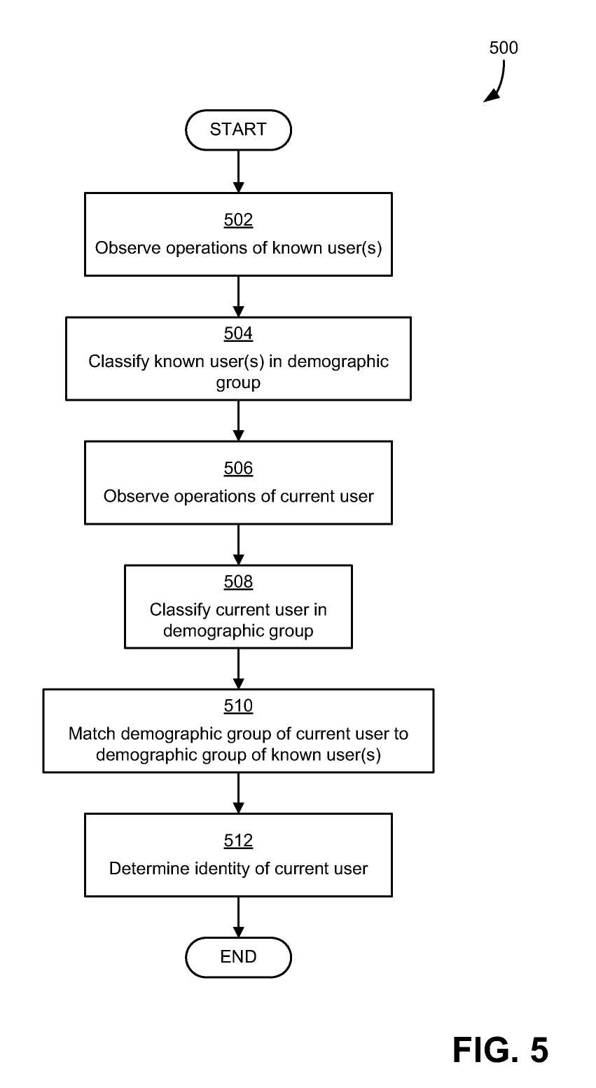

FIGS. 4 and 5 illustrate another exemplary technique for identifying a current user that may be used as an alternative to the processes of FIGS. 2 and 3 or in addition to the processes of FIGS. 2 and 3 as a way of further identifying a current user. In the technique of FIGS. 4 and 5, known users may be identified as being in one or more user categories, such as demographic or interest categories. Based on observing a known user's operations, a known user may be identified as being in a particular user category. The user category for the current user may then be used to recognize the current user as a known user in that user category and/or to identify as being a particular type of user such that preference information for the user category may be used to customize presentation of services to the current user.

The process 400 of FIG. 4 begins in block 402, in which a seed group of users matching in each category of interest is identified. These users may be volunteers, and may specify various demographic characteristics about themselves to match them to a demographic group of interest. Any suitable categories may be used, depending on the environment in which these techniques are used. For example, broad demographic categories such as men and women or adults and children may be used, or more specific categories may be identified for demographic groups of interest and used. As another example, user interest categories may be established, such as users interested in sports, cars, cooking, or other interests.

In block 404, operations carried out by the users in the seed groups are observed, as in the manner described above in connection with FIGS. 1, 2, and 3. Any suitable operation may be observed in any suitable manner. Based on this observation, in block 406 characteristics of the behavior of seed group for a category (e.g., demographic or interest category) may be identified. These may be any suitable characteristics based on analyzing the operations of an entire category and identifying trends. For example, the types of software applications executed by users in a category, or the input devices typically used by the users to carry out operations (e.g., typically using keyboards or typically using computer mice), or times that operations are carried out may be tracked and identified as characteristics, though other characteristics may be identified as well.

In block 408, once characteristics for a seed group of a category are identified, the characteristics for the seed group are distributed such that they may be used for identifying current users of computers, and the process 400 ends.

FIG. 5 shows an exemplary process 500 for identifying a current user based on the characteristics of a category identified by, for example, a process like process 400. Process 500 begins in block 502, in which operations of one or more known users are observed and identify characteristics of those operations identified. This may be done in any suitable manner, including by some of the exemplary techniques describes above in connection with FIGS. 1, 2, and 3.

In block 504, based on this observation and the characteristics that are identified, a known user may be identified as being in one or more categories. In some cases, the categories may be mutually exclusive, so a known user may be identified as being in one category, while in other cases the categories may overlap and multiple categories may be identified for a particular known user. This classification may be done through comparing operation characteristics for a particular known user to operation characteristics for users of various categories (i.e., the characteristics of the seed group operations), and determining based on that comparison which category(ies) the known user is in. The identified category(ies) may be one determined to have characteristics that are the closest match to the characteristics of the known user, such as by applying statistical correlation techniques like those used in regression analysis or segmentation problems.

Once known users are classified into one or more categories in block 504, these categories may be used to identify a current user as a known user. This may be done by, for example, identifying the current user as being in one or more categories (e.g., demographic or interest categories).

To do so, in block 506 operations of the current user are observed (in any suitable manner, as above) and characteristics of those operations may be identified. In block 508, these characteristics are used in a similar manner to that of block 504 to classify the current user as being in one or more categories.

In block 510, the identified category(ies) for the current user may be used to identify, in block 512, the current user as a known user by matching the category(ies) to those of known users. For example, if a current user is matched to three particular categories based on characteristics, and only one known user is in all three categories, the current user may be identified as the known user. Similarly, if a current user is matched to one category, but only one known user is in that category, the current user may be identified as the known user. If, however, multiple known users are in the category(ies) of the current user, then the user may be identified as being one of the users and/or other techniques may be applied to narrow the identification.

Once the current user is recognized in block 512, the process 500 ends. As discussed above, this recognition may be used in any suitable manner, such as to customize presentation of services by a computer component to the current user based on preferences identified for the current user. For example, preferences of a known user, whom the current user was identified to be in block 512, may be retrieved and used to customize presentation of services.

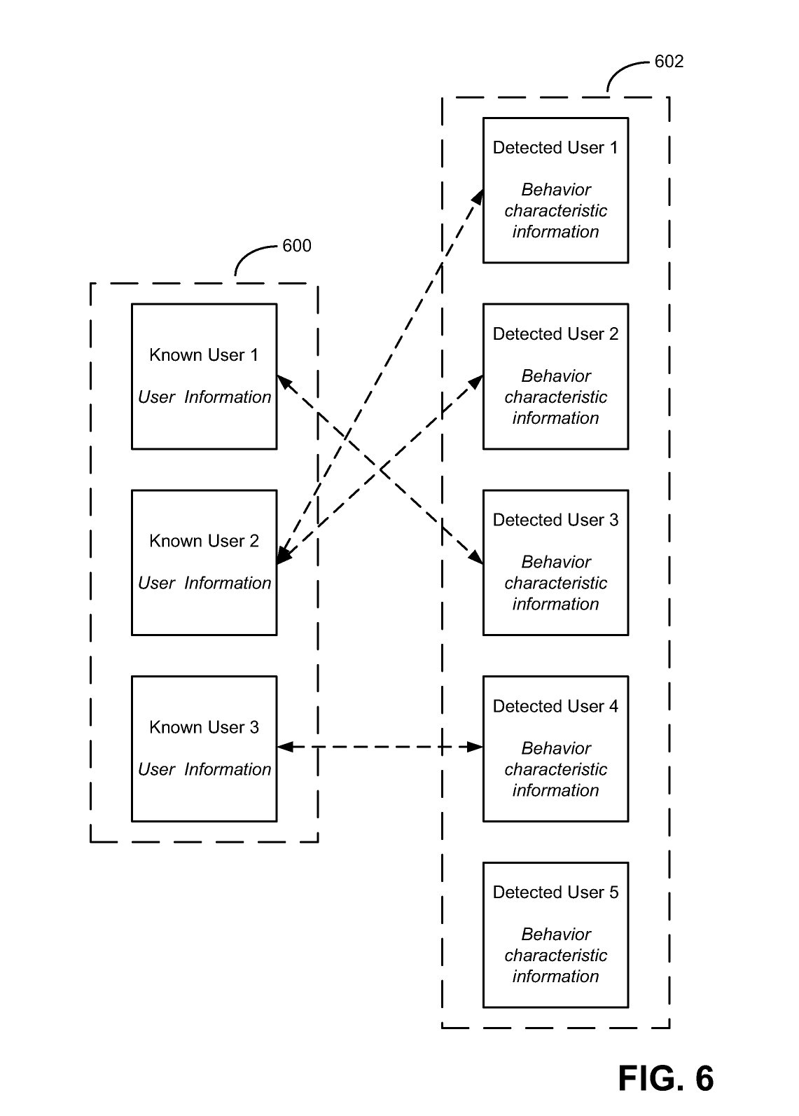

Various examples of ways in which operations of a current user may be used to identify the current user have been discussed generally above. When such techniques are used, information on known users and operations of known users may be stored in any suitable manner. FIG. 6 shows one way in which operation information may be stored by some embodiments of the invention, though others are possible.

FIG. 6 shows two data stores each storing information on users of a computer component. Data store 600 is storing user profile information for three known users of the computer component, including any suitable user profile information. For example, identifying information for a known user like a user name or demographic may be stored, as well as preference information for the known user that may identify one or more ways in which the known user may desire a service to be customized.

Data store 602 stores information on detected users of a computer component. As discussed above, a detected user is a data set of operation characteristics that may correspond to a new or known user, and may be used to recognize a current user. Each detected user profile stored in data store 602 may be associated with behavioral characteristic information for one or more new or known users, which may include any suitable information on operations or properties of operations. Frequent or common operations carried out by the detected user may be identified, including common types of operations performed with respect to a computer component or with respect to multiple computer components of a computer system. Such operations may include operations to start a software application and operations to request a particular content or type of content from a software application. Information about the frequent/common operations may also be stored, such as a time of day at which the operation(s) are executed, a speed with which the operation or a set of operations is carried out, a type of input device used to carry out of the operation, or any other suitable data regarding operations.

In accordance with techniques described herein, information on known users that may be stored in data store 600 may be compiled in response to direct user input regarding the user (e.g., in response to prompts for user demographic information and/or preference information) and/or through observing user operations that may indicate user preference information. For example, if a known user spends a lot of time reading sports-related web pages, the known user may be detected to have a preference for sports. This preference may be stored as an indication that a user is a member of one or more categories, such as interest categories, as discussed above.

Detected user information to be stored in data store 602 may be compiled from observing user operations. Detected user information may be compiled either when a current user is known to be a known user, when a current user is being recognized, or at any other suitable time. Detected user information may be collected that tracks identities of detected users—that may or may not match to known users—based on various trends in characteristics of behavior. When trends are identified in behavior of a current user that indicate that the current user is a person different from any other detected user (e.g., the characteristics do not match any other detected user), a new detected user may be created and information on those characteristics stored, such that characteristics of operations may be stored for the different person. Trends may be identified to be used in this way using any suitable technique, including examples described herein. For example, characteristics of user categories, as discussed above in connection with FIGS. 4 and 5, may be used to indicate that a detected user should be created, such as when a current user is identified as belonging to a user category different from any categories to which known users belong. Additionally or alternatively, operation characteristics that may be associated with a single person—for example, e-mail addresses or web site log-in information—may be used to indicate that a detected user data set should be created for a different person, such as when a new e-mail address is used. Additionally, such trends may be used to identify when a previously-detected user is using a computer component and, accordingly, that behavior characteristics should be compiled and used to update the profile of the detected user.

A detected user may be matched to a known user, as shown in FIG. 6. This may be done in any suitable manner, such as by observing operation characteristics of a current user immediately following log-in of a known user (which may be assumed to be the characteristics of the known user). The operation characteristics of the current user, in this case, can be matched to characteristics of a detected user, and the detected user may be identified as corresponding to the known user.

Further, in some embodiments, previously-determined user categories for a known user may be matched to user categories inferred about a detected user based on operation characteristics—similar to the techniques described above in connection with FIGS. 4 and 5—and thus the detected user may be identified as corresponding to the known user.

Additionally, in some embodiments of the invention, if a detected user is created in the data store 602 based on operations of a current user, the current user may be prompted to identify him- or herself as a known user to establish a correspondence between the detected user and a known user.

Though these examples have been given of techniques for matching a detected user to a known user, it should be appreciated that any suitable technique may be used for matching a known user to a detected user in embodiments of the invention that store detected user information in the manner shown in FIG. 6.

In the example of FIG. 6, examples of matches between detected users and known users are shown. Detected user 1 is matched to known user 2, detected user 3 is matched to known user 1, and detected user 4 is matched to known user 3. Further, in some embodiments of the invention, two or more detected users may be matched to one known user, as shown by detected users 1 and 2. This may be done because a particular known user may use a computer component in two different ways, such as different ways in the morning and in the evening, and thus may have different behavior trends. Additionally, a known user may use two e-mail addresses, and if a detected user is associated with a particular e-mail address, the known user with the two e-mail addresses may be associated with both detected users. As discussed above, a detected user may be created for each set of behavior trends for a current user, such that if a known user uses a computer in different ways, then two different detected users may be created. Using different detected users for different types of behavior of one known user may be advantageous in that it may allow for a closer match between operations of a current user and types of behavior of a known user than by generalizing operation characteristics of a known user to include all types of behavior. It should be appreciated, though, that this approach is not necessary, and that embodiments of the invention that store information in the manner shown in FIG. 6 may operate with only one detected user per known user. In such a case, if a known user, when matched to a first detected user profile, is already matched to a second detected user profile, that second detected user profile may be updated to include the information from the first to maintain the one-to-one correspondence.

It should be appreciated that in some embodiments of the invention, a detected user may be identified by trends or other characteristics of user interactions with the computer even if that detected user may be matched to a known user. This is shown in FIG. 6, where a detected user has been recognized as a unique user, but is not matched to any known user. A detected user may not be matched to a known user in the case where a person that is the detected user does not yet have a user profile (i.e., is a new user).

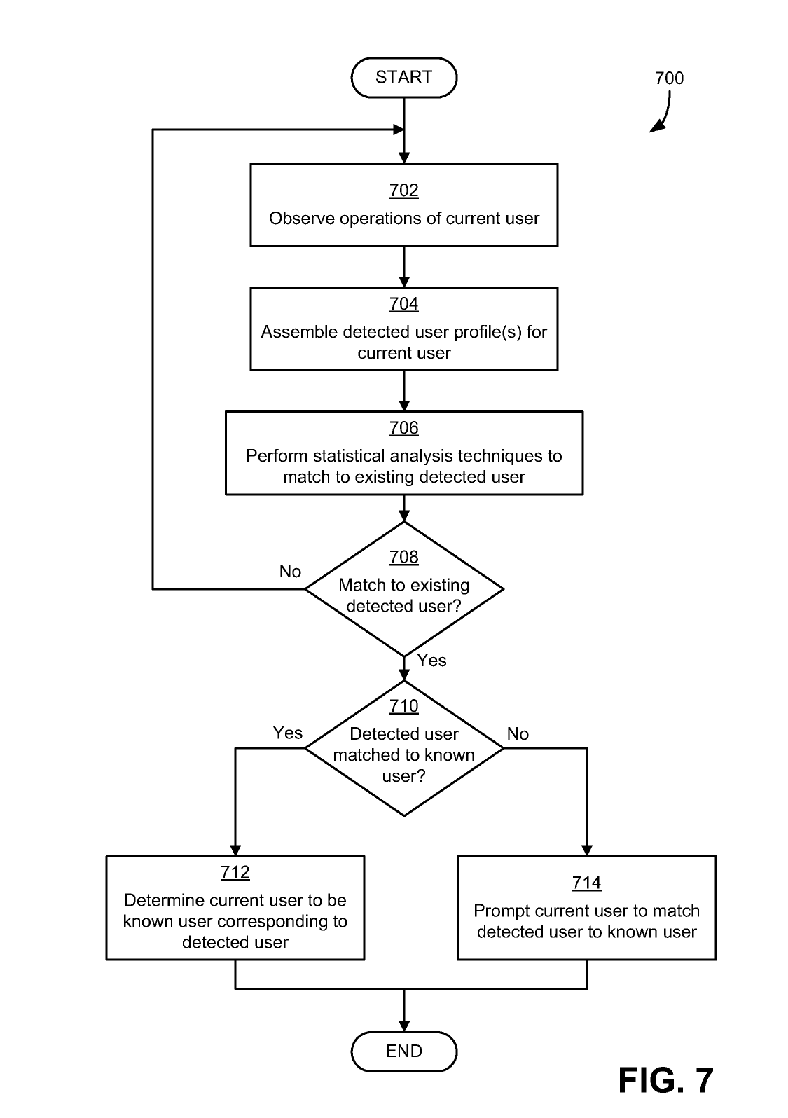

In embodiments of the invention that store information on known and detected users in the manner shown in FIG. 6, any suitable technique may be applied for using the stored information to identify a current user of a computer component. One example of such a technique is shown in FIG. 7.

The exemplary process 700 of FIG. 7 begins in block 702, in which operations of a current user are observed and characteristics of those operations are identified. This can be done in any suitable manner, including the examples discussed above in connection with FIGS. 1, 2, and 3. In block 704, the characteristics of these operations are used to assemble a detected user for the current user. The detected user created in block 604 may include any suitable information about behavior characteristics of a current user and/or other information that may have been inferred from those characteristics, including user category information.

In block 706, statistical correlation techniques, including techniques used in regression analysis and segmentation problems, are applied to match the detected user for the current user that was created in block 704 to an existing detected user. In block 708, it is determined whether a match was identified. If not, then processing for process 700 returns to block 702, in which additional user operations are observed to compile more information for the current user to aid in making a match. While not shown in FIG. 7, if, after some time or threshold number of comparisons, the detected user profile for the current user is not matched to any existing detected users, that profile may be stored as a detected user (e.g., stored in the data store 602) for future use in matching or matching to a known user.

If, however, an existing detected user is matched to the detected user profile for the current user in block 708, then in block 710 it is determined whether that detected user profile is matched to a known user. If so, then in block 712 the current user is determined to be the known user corresponding to that detected user, and the process 700 ends. Presentation of services by a computer component may then be customized according to the preferences of that known user, such as by retrieving preference information for that known user and using it to customize the services.

If it is determined in block 710 that the matched detected user is not matched to a known user, then in block 714 the current user may be prompted to match the detected user to a known user. The current user may be prompted to his- or herself from a listing of known users, and the detected user may be matched to a known user based on that input. The current user may also be able to select that he/she is not a known user, and create a new user profile to match with the detected user. Once the current user inputs his/her identity as a user and the detected user is matched to a known user, the process 700 ends.

In various exemplary techniques described above, comparison of operation characteristics of a current user to operation characteristics of known users is described as being done with statistical correlation techniques. It should be appreciated, however, that not all embodiments of the invention may use statistical correlation techniques to match a current user to a known user, and rather than any suitable comparison technique may be used. In some embodiments of the invention, for example, a matching score may be calculated based on identifying particular operations of a current user, assigning weights to those operations, and maintaining an aggregate matched score for potential known users that the current user may be. If the aggregate matched score for a known user exceeds a threshold, then the current user may be identified as that known user.

The weights assigned to the operation characteristics, in such a case, may correspond to how strongly those operations may indicate the identity of a user. Opening a particular software application may not be very indicative of an identity of a user in some circumstances, so an operation to open that software application may be weighted low. Logging in to a particular web site with a user name, or sending an e-mail using a particular address, however, may be more significant and more indicative of a particular user in some circumstances, and the operation may be weighted more. Any suitable system of weights for operations may be used in various embodiments that use this technique for comparison.

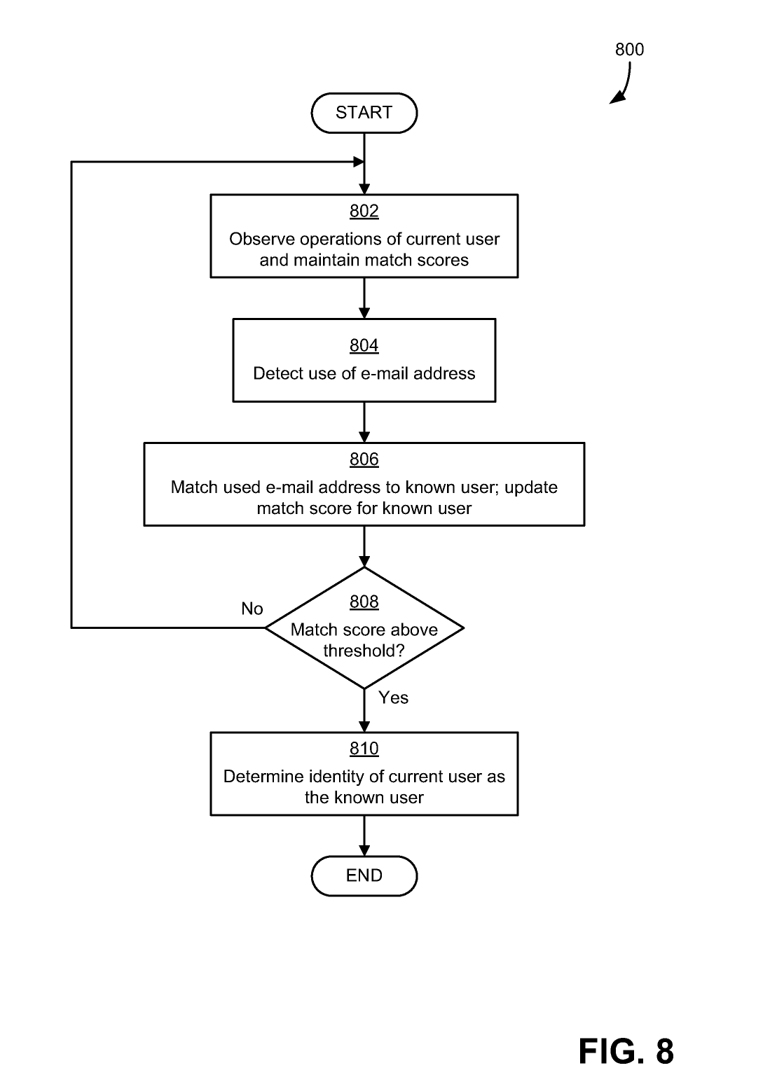

FIG. 8 shows one exemplary process 800 for recognizing a user based on a system of weights for operations. The process 800 begins in block 802, in which operations of a current user are observed for matches to predetermined operations, types of operations, and operation properties. These predetermined operations, types, or properties may correspond to a listing of weights, such that when an operation/type/property is observed, the corresponding weight may be retrieved. This system of weights may then be used to maintain a listing of match scores in block 802. The set of match scores that is maintained may correspond to each of the known users for a computer component, such that a match score for matching the current user to each known user is maintained.

Maintaining the match scores may be done by observing the operations and aggregating a score for each known user based on a correspondence between the current user and properties of a known user. In block 804, for example, a use of an e-mail address in an operation is detected (e.g., sending or receiving an e-mail using the e-mail address, typing the e-mail address into an input form on a web page, etc.). In block 806, that e-mail address used in the operation is compared to known e-mail addresses for known users and a match to a particular known user is found. Based on this match, the weight assigned to an operation using an email address is received and the match score corresponding to the particular known user is updated using that weight.

It should be appreciated that while the comparison and updating of block 806 is for a particular user, in some implementations and based on some properties, match scores for a plurality of known users may be updated when an operation or operation characteristic matches a plurality of users.

In block 808, it is determined, based on updated match scores for known users based on the update of block 806, whether a match score for a particular user is above a specified threshold. If so, then it may be determined in block 810 that the current user is the known user with the match score above the threshold, as the operations of the current user match the operations of the known user to that specified degree. Upon identification of the current user, the process 800 ends.

If, however, no match score for a known user is above the threshold, then processing for process 800 may return to block 802, wherein further operations of the current user are observed to attempt to recognize the current user.

In some embodiments of the invention, when the current user is recognized as a known user, the current user may immediately be assumed to be the known user and the presentation of services to the current user may be customized according to preferences of the known user. In other embodiments of the invention, though, a user may be prompted to confirm the identity that was determined. Any suitable user interface may be used to prompt the user.

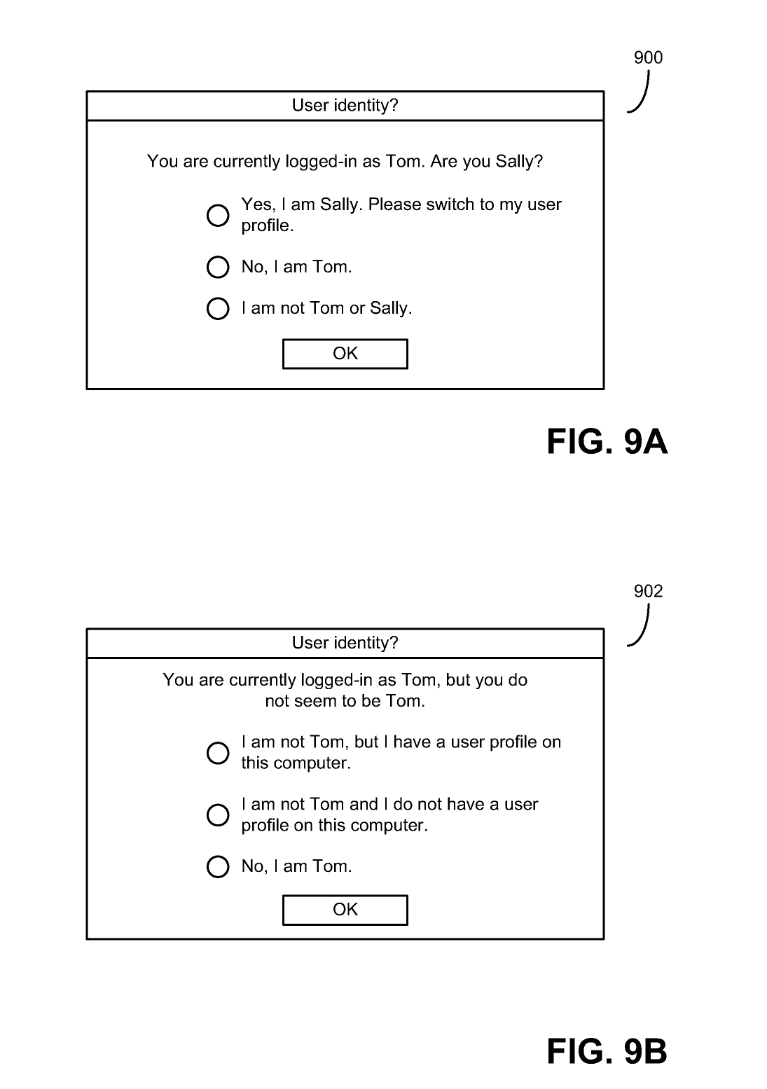

FIG. 9A is an example of one type of user interface that may be displayed to a current user to confirm the identity of the user. The interface 900 informs the current user that he/she is currently logged-in to the computer component as a first user, Tom, but has been detected to be a second user, Sally. The current user is then given three options: first, to confirm that she is Sally and switch to Sally's user profile; second, to deny that he is Sally and confirm that he is Tom; and third, to declare that he/she is neither Tom nor Sally. In the case that the user selects the third option, the user may be additionally prompted to select his/her user profile and/or to create a new user profile.

FIG. 9B is another exemplary type of user interface that may be displayed to a current user to receive input regarding identity of the current user. Interface 902, unlike interface 900, does not provide the user with an identification of the current user, but rather only informs the current user that he/she is currently logged-in as Tom but does not appear to be Tom. The user is then given the option to declare that he/she is not Tom and select his/her own user profile, select that he/she is not Tom and indicate that he/she does not have a user profile (in which case, an additional prompt may be displayed to create a user profile), or confirm that he is Tom. Such an interface may be useful in some circumstances where users may not be comfortable having their exact identity displayed to them, for fear of privacy implications, and would rather select their own identity from a list.

While two exemplary user interfaces have been shown, it should be appreciated that these are merely exemplary, and any other suitable user interface may be displayed.

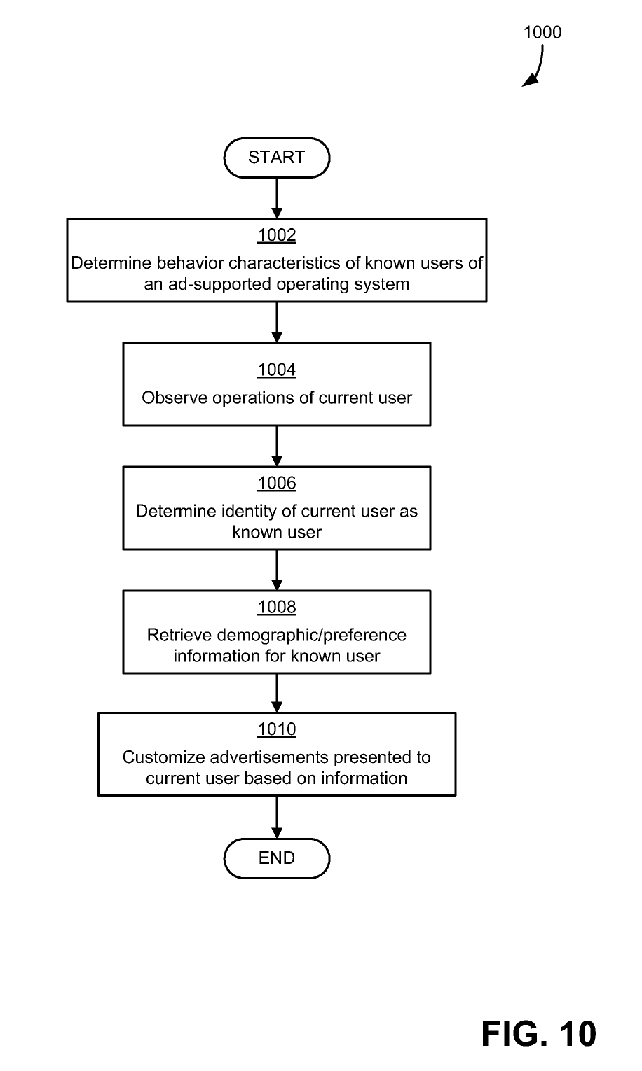

The techniques described herein for identifying a current user based on observing characteristics associated with operations of the current user can be used in any suitable environment and applied to any suitable computer component for customizing presentation of services of that component based on the user's preferences. FIG. 10 shows one example of an application of these techniques in one illustrative environment, but it should be appreciated that others are possible.

The embodiment of the invention illustrated in FIG. 10 operates with a computer component that is an operating system, and may provide services in the form of advertisements. The identity of a current user could be used, in accordance with the techniques described herein, to customize presentation of these advertisements to the current user.

Operating systems for computers and computing devices require a great deal of time and resources to develop, and typically are sold for a one-time price per license. This is not necessary, though. Instead, users could be offered free or reduced-price licenses in exchange for viewing advertisements while using a computer on which the operating system is executing. This advertising may be conventional text-, image-, or video-based advertising, such as that advertising a product or service of a company. For example, one such advertisement may be a sidebar on a user interface that updates throughout the day by offering statistics and news headlines about a particular sport or sports team.

Advertisers that may sponsor for conventional or service-based advertisements may be willing to pay more for their advertisements if they can be certain that the advertisements will be displayed to those users that are in a target demographic or are interested in those advertisements. Further, users of the operating system may be bothered less by advertisements that interest them, such that their interactions with the operating system are more pleasant. However, as discussed above, in many cases an identity of a logged-in user may not correspond to an identity of a current user. Thus, some of the techniques described herein may be used for identifying with more certainty a current user and then customizing presentation of advertisement content to the current user.

FIG. 10 shows one example of a process that may be used to recognize a current user of an operating system such that advertisements may be offered to the user based on preferences of the user.

The process 1000 of FIG. 10 begins in block 1002, in which behavior characteristics of known users of the advertisement-supported operating system are determined. These behavior characteristics may be determined in any suitable manner, including by observing operations of the known users and storing characteristic information derived from those observed operations. Any suitable technique may be used for observing the operations and deriving characteristic information, examples of which are discussed above.

In block 1004, operations of a current user of the advertisement-supported operating system are observed. The operations that are observed may be any suitable operation, including those that interact with the operating system itself and operations that interact with other software applications executing on the computing device hosting the operating system. For example, one operation that may be observed is requesting the operating system to execute a particular software application, such as a spreadsheet application or a web browser application. Another operation that may be observed is one that operates a web browser application to retrieve a particular web page (e.g., by inputting a URL for a web page) or that inputs information into a web page (e.g., into a web form of a web page). While, in this case, the computer component is the operating system, as discussed above any suitable operations of a current user may be observed, including those that interact with other computer utilities or components of a computer system (such as these other software applications).

In block 1006, based on the observed operations of block 1004, and through the application of any suitable comparison technique such as statistical correlation techniques or match scores, the current user is determined to be a particular known user. In some embodiments of the invention, the current user may then be prompted to confirm this identification, but it is not necessary.

In block 1008, demographic, interest category and/or preference information of the known user identified in block 1006 are retrieved from the user profile of the known user. This demographic/preference information may be any suitable information about a known user, including information on interests of the user or likes/dislikes of the user.

In block 1010, the demographic/preference information is used to customize presentation of advertisements to the current user. This may be done in any suitable manner. As discussed above, in some cases it may be desirable to perform all processing of user information locally, on the computing device on which it was collected, to ensure that user information is not transmitted outside of the computing device. This prevents the user information from being intercepted and misused. Accordingly, in some embodiments of the invention, the demographic/preference information may be used in block 1010 to identify advertisements in which the current user may have an interest from a set of advertisements that have already been downloaded. In this way, no identifiable information about the user is sent out of the device. However, in other cases the information may be used to retrieve particular advertisement content, or may be transmitted outside of the device and processed to identify advertisements to be transmitted to the device in response.

In some embodiments of the invention that display advertisements received via a network, an advertising platform may be implemented that includes a client computer on which the advertisements may be displayed and an advertisement server that stores advertisements and transmits them to the client computer for display. The advertisement server may, in some embodiments, transmit a set of potential advertisements to the client computer, and the client computer may select an advertisement to display based on user preferences, such that no user-identifiable information is transmitted outside of the client computer. In other cases, though, the client computer may transmit some indication of user preferences, such as one or more user categories that describe a user's demographics or interests, and the advertising server may select an advertisement and transmit the advertisement to the client computer.

It should be appreciated, though, that any suitable technique may be used to identify advertisements in which the user may be interested.

Once the advertisements are customized based on the current user's preferences, they may be presented to the user by being displayed visually and/or audibly, and the process 1000 ends.

Techniques operating according to the principles described herein may be implemented in any suitable manner. Included in the discussion above are a series of flow charts showing the steps and acts of various processes that identify a current user of a computer component based on the behavior of the current user, and customize presentation of services based on the preferences of the current user. The processing and decision blocks of the flow charts above represent steps and acts that may be included in algorithms that carry out these various processes. Algorithms derived from these processes may be implemented as software integrated with and directing the operation of one or more multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one of ordinary skill in the art may use to fabricate circuits or to implement computer software programs to perform the processing of a particular apparatus carrying out the types of techniques described herein. It should also be appreciated that, unless otherwise indicated herein, the particular sequence of steps and acts described in each flow chart is merely illustrative of the algorithms that may be implemented and can be varied in implementations and embodiments of the principles described herein without departing from the invention.

Accordingly, in some embodiments, the techniques described herein may be embodied in computer-executable instructions implemented as software, including as application software, system software, firmware, middleware, or any other suitable type of software. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations needed to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package, and thus may be incorporated into any suitable computer component. For example, functional facilities operating according to techniques described herein may be incorporated into a computer component that is a software program application. In other implementations, the functional facilities may be adapted to form a part of a computer component that is an operating system, including the Windows operating system available from the Microsoft Corporation of Redmond, Wash. In other words, in some implementations, the functional facilities may be implemented alternatively as a portion of or outside of an operating system.

Some exemplary functional facilities have been described herein for carrying out one or more tasks, such as for identifying a current user and/or customizing presentation of services. It should be appreciated, though, that the functional facilities and division of tasks described is merely illustrative of the type of functional facilities that may implement the exemplary techniques described herein, and that the invention is not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

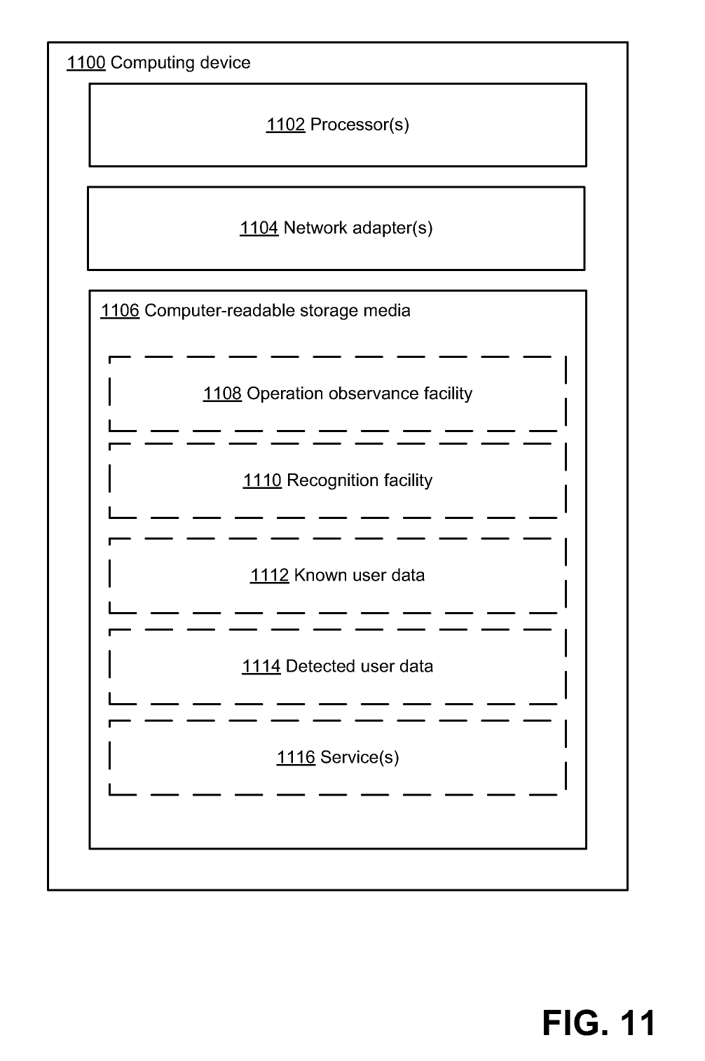

Computer-executable instructions implementing the techniques described herein (when implemented as one or more functional facilities or in any other manner) may, in some embodiments, be encoded on one or more computer-readable storage media to provide functionality to the storage media. These media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable storage medium may be implemented as computer-readable storage media 1106 of FIG. 11 described below (i.e., as a portion of a computing device 1100) or as a stand-alone, separate storage medium. It should be appreciated that, as used herein, a “computer-readable media,” including “computer-readable storage media,” refers to tangible storage media having at least one physical property that may be altered in some way during a process of recording data thereon. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system. Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 11 illustrates one exemplary implementation of a computing device in the form of a computing device 1100 that may be used in a system implementing the techniques described herein, although others are possible. It should be appreciated that FIG. 11 is intended neither to be a depiction of necessary components for a computing device to operate in accordance with the principles described herein, nor a comprehensive depiction.

Computing device 1100 may comprise at least one processor 1102, a network adapter 1104, and computer-readable storage media 1106. Computing device 1100 may be, for example, a desktop or laptop personal computer, a personal digital assistant (PDA), a smart mobile phone, a server, or any other suitable computing device that may be operated by a user and may present services to a user. Network adapter 1104 may be any suitable hardware and/or software to enable the computing device 1100 to communicate wirelessly with any other suitable computing device over any suitable computing network. The computing network may include a wireless access point as well as any suitable wired and/or wireless communication medium or media for exchanging data between two or more computers, including the Internet. Computer-readable media 1106 may be adapted to store data to be processed and/or instructions to be executed by processor 1102. Processor 1102 enables processing of data and execution of instructions. The data and instructions may be stored on the computer-readable storage media 1106 and may, for example, enable communication between components of the computing device 1100.

The data and instructions stored on computer-readable storage media 1106 may comprise computer-executable instructions implementing techniques which operate according to the principles described herein. In the example of FIG. 11, computer-readable storage media 1106 stores computer-executable instructions implementing various facilities and storing various information as described above. Computer-readable storage media 1106 may store an operation observance facility 1108 to observe operations of a current user and/or to identify characteristics of those operations. A recognition facility 1110 may also be stored on computer-readable storage media 1106 and used to recognize a current user of a computer component based on information about known users of the component. Known user data 1112 and detected user data 1114 may also be stored in some embodiments of the invention, and may be used to recognize a current user and/or customize presentation of services by computer utilities based on the identity of the current user. Lastly, one or more services 1116 may be stored that may be customized for presentation to a user based on the identity of the user and preferences of the user.

In the embodiment illustrated, elements 1108, 1110, 1112 and 1114 may be components of or implemented within an operating system. Services 1116 may be implemented as an application interacting with the operating system. Though, such an implementation is exemplary and not limiting of the invention.

While not illustrated in FIG. 11, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments of the invention have been described where the techniques are implemented in circuitry and/or computer-executable instructions. It should be appreciated that the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method for recognizing a current user of a computer based on behavior of the current user and customizing presentation of at least one service to the current user based on the recognizing, the method comprising:
operating at least one processor of the computing device to perform acts comprising:
(A) receiving log-in information, the log-in information being received for a logged-in user;
(B) observing operations of the current user of the computer;
(C) comparing characteristics of the operations of the current user to characteristics of operations of at least one known user of the computer;
(D) recognizing the current user as a recognized known user from among the at least one known user, the recognizing being based on the comparing of act (C), and the recognized known user being different from the logged-in user; and
(E) customizing presentation of the at least one service to the current user based on preference information of the recognized known user.

2. The method of claim 1, wherein:
the acts (A), (B), (C) and (D) are performed in an advertisement-supported operating system of the computing device, and
the act (E) of customizing presentation of at least one service comprises customizing presentation of advertisements to the current user based on preferences of the known user.

3. The method of claim 1, wherein the act (B) of observing comprises:
(B1) observing operations of the current user that interact with at least one software application program executing on the computing device.

4. The method of claim 3, wherein observing operations of the current user that interact with the at least one software application program in the act (A1) comprises observing operations of the current user that interact with at least one software application program that is not providing the at least one service for which presentation is customized in the act (E).

5. The method of claim 1, wherein the act (C) of comparing comprises:
(C1) assigning weights to different operation types, and
(C2) basing a determination of whether the current user is a known user at least in part on the weights.

6. The method of claim 5, wherein the act (C) of comparing further comprises:
(C3) detecting that the current user is the recognized known user upon detection that a first operation of an operation type having a high weight has been carried out.

7. The method of claim 6, wherein the first operation is logging into at least one computer component using a user identifier associated with the recognized known user.

8. The method of claim 1, further comprising;
(F) when the current user is not recognized in the act (D) as a recognized known user, creating a new user profile for the current user.

9. The method of claim 1, further comprising:
(F) prompting the current user to provide log-in information.

10. At least one computer-readable storage medium encoded with computer-executable instructions that, when executed by at least one computer, perform a method for recognizing a current user of a computing device comprising an operating system based on behavior of the current user, the method comprising:
(A) receiving log-in information, the log-in information being received for a logged-in user;
(B) observing operations of the current user of the operating system when interacting with a plurality of software applications executing on the computing device;
(C) comparing characteristics of the operations of the current user to characteristics of operations of at least one known user;
(D) recognizing the current user as a recognized known user based on the comparing of act (C), the recognized known user being different from the logged-in user;
(E) prompting the current user to provide log-in information for the known user; and
(F) if the current user provides the log-in information, displaying at least one advertisement to the current user, via the operating system, based on preferences of the known user,
wherein the computer executable instructions performing acts (A), (B), (C), (D) and (E) are a portion of an operating system.

11. The at least one computer-readable storage medium of claim 10, wherein the act (C) of comparing comprises:
(C1) assigning weights to different operation types, and
(C2) basing a determination of whether the current user is a known user at least in part on the weights.

12. The at least one computer-readable storage medium of claim 10, wherein the act (C) of comparing comprises applying at least one statistical correlation technique to match the current user to one or more detected users.

13. The at least one computer-readable storage medium of claim 12, wherein the act (B) of observing operations of the current user comprises creating a detected user data set for the current user, and
wherein the at least one statistical correlation technique is applied to determine a match between profiles for the one or more detected users and the detected user data set for the current user.

14. The at least one computer-readable storage medium of claim 10, wherein the method further comprises:
(G) determining at least one user category for the current user based at least in part on the operations observed in the act (B), and
wherein the act (C) of comparing the current user to the at least one known user comprises comparing a determined user category for the current user to a user category of a known user to determine whether there is a match.

15. The at least one computer-readable storage medium of claim 10, wherein the method further comprises:
(G) if the current user is not recognized in the act (D) as a known user, prompting the current user to create a new user profile.

16. An apparatus for recognizing a current user of the apparatus based on behavior of the current user and customizing presentation of at least one service to the current user based on the recognizing, the apparatus comprising:
at least one memory storing information on at least one known user, the information comprising preference information for the at least one known user; and
at least one processor adapted to:
receive log-in information for a logged-in user of the apparatus;
observe operations of the current user of the apparatus;
perform a comparison of characteristics of operations of the current user to characteristics of operations of the at least one known user of the apparatus;
recognize the current user as a recognized known user from among the at least one known user, the recognizing being based on the comparison, and the recognized known user being different from the logged-in user;
prompt the current user to provide log-in information for the recognized known user; and
if the current user provides the log-in information, customize presentation of the at least one service to the current user based on preference information of the recognized known user.

17. The apparatus of claim 16, wherein the at least one processor is adapted to observe operations of the current user by observing operations of the current user that interact with a plurality of software application programs executing on the apparatus.

18. The apparatus of claim 16, wherein the at least one processor is adapted to perform the comparison by applying at least one statistical correlation technique to match the current user to one or more detected users.

19. The apparatus of claim 18, wherein the at least one memory stores information on one or more detected users,
wherein the at least one processor is adapted to create a detected user data set for the current user based on the operations of the current user that are observed, and
wherein the at least one statistical correlation technique is applied to determine a match between the information for the one or more detected users and the detected user data set for the current user.

20. The apparatus of claim 16, wherein the at least one processor is further adapted to, if the current user is not determined to be a recognized known user, create a new user profile for the current user.
